(19) United States
(12) Patent Application Publication
(10) Pub. No.: US 2016/0191581 A1
(43) Pub. Date: Jun. 30, 2016

(54) APPARATUS, SYSTEM AND METHOD OF MEDIA STREAMING

(71) Applicant: INTEL CORPORATION, Santa Clara, CA (US)

(72) Inventors: Izoslav Tchigevsky, Portland, OR (US); Noam Ginsburg, Haifa (IL)

(21) Appl. No.: 14/582,936

(22) Filed: Dec. 24, 2014

(51) Int. Cl. H04L 29/06

(52) U.S. Cl. CPC H04L 65/4069; H04L 65/607

(57) ABSTRACT

Some demonstrative embodiments include apparatuses, devices, systems and methods of video streaming. For example, an encoder to receive from a graphic processor a video stream to be transmitted to a wireless display, and to encode the video stream into an encoded video stream; and a wireless communication unit to communicate with the wireless display, to receive an indication that the encoded video stream is to be streamed in a burst, to receive the encoded video stream from the encoder, and to transmit the encoded video stream to the wireless display based on the indication.

### TECHNICAL FIELD

Embodiments described herein generally relate to media streaming.

### BACKGROUND

A wireless communication device, e.g., a Smartphone, a notebook, and/or the like, may be configured to stream media content via a wireless medium to a remote display. The media content may include audio and/or video to be displayed on a remote display.

The wireless medium is characterized by a reduced reliability and/or a significant latency. The reliability and/or the latency of the wireless medium may reduce quality of the video and/or the audio when received by the remote display.

The media content may be streamed via a wireless communication unit of the wireless communication device.

The wireless communication unit may provide, for example, Internet connectivity to the wireless communication device, e.g., in addition to the streaming of the media content.

Providing the Internet connectivity while streaming the media content by the wireless communication unit may further reduce the quality of the video and/or the audio when received by the remote display.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1 is a schematic block diagram illustration of a system, in accordance with some demonstrative embodiments.

FIG. 2 is a schematic block diagram illustration of a processing scheme to transmit media content, in accordance with some demonstrative embodiments.

FIG. 3 is a schematic block diagram illustration of a processing scheme to transmit media content, in accordance with some demonstrative embodiments.

FIG. 4 is a schematic block diagram illustration of a processing scheme to transmit media content, in accordance with some demonstrative embodiments.

FIG. 5 is a schematic sequence diagram of media streaming, in accordance with some demonstrative embodiments.

FIG. 6 is a schematic flow chart illustration of a method of media streaming, in accordance with some demonstrative embodiments.

FIG. 7 is a schematic illustration of a product of manufacture, in accordance with some demonstrative embodiments.

### DETAILED DESCRIPTION

In the following detailed description, numerous specific details are set forth in order to provide a thorough understanding of some embodiments. However, it will be understood by persons of ordinary skill in the art that some embodiments may be practiced without these specific details. In other instances, well-known methods, procedures, components, units and/or circuits have not been described in detail so as not to obscure the discussion.

Discussions herein utilizing terms such as, for example, “processing”, “computing”, “calculating”, “determining”, “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “plurality” and “a plurality”, as used herein, include, for example, “multiple” or “two or more”. For example, “a plurality of items” includes two or more items.

References to “one embodiment”, “an embodiment”, “demonstrative embodiment”, “various embodiments” etc., indicate that the embodiment(s) so described may include a particular feature, structure, or characteristic, but not every embodiment necessarily includes the particular feature, structure, or characteristic. Further, repeated use of the phrase “in one embodiment” does not necessarily refer to the same embodiment, although it may.

As used herein, unless otherwise specified the use of the ordinal adjectives “first”, “second”, “third” etc., to describe a common object, merely indicate that different instances of like objects are being referred to, and are not intended to imply that the objects so described must be in a given sequence, either temporally, spatially, in ranking, or in any other manner.

Some embodiments may be used in conjunction with various devices and systems, for example, a User Equipment (UE), a Mobile Device (MD), a wireless station (STA), a Bluetooth device, an Internet of Things (IoT) device, a Personal Computer (PC), a desktop computer, a mobile computer, a laptop computer, a notebook computer, a tablet computer, a server computer, a handheld computer, a handheld device, a Personal Digital Assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless Access Point (AP), a wired or wireless router, a wired or wireless modem, a video device, an audio device, an audio-video (A/V) device, a wired or wireless network, a wireless area network, a Wireless Video Area Network (WVAN), a Local Area Network (LAN), a Wireless LAN (WLAN), a Personal Area Network (PAN), a Wireless PAN (WPAN), and the like.

Some embodiments may be used in conjunction with devices and/or networks operating in accordance with existing IEEE 802.11 standards (IEEE 802.11-2012, IEEE Standard for Information technology—Telecommunications and information exchange between systems Local and metropolitan area networks—Specific requirements Part 11: Wireless LAN Medium Access Control (MAC) and Physical Layer (PHY) Specifications, Mar. 29, 2012; IEEE802.11ac-2013 (“IEEE P802.11ac-2013, IEEE Standard for Information Technology—Telecommunications and Information Exchange Between Systems—Local and Metropolitan Area Networks Specific Requirements—Part 11: Wireless LAN Medium Access Control (MAC) and Physical Layer (PHY) Specifications—Amendment 4: Enhancements for Very High Throughput for Operation in Bands below 6 GHz”, December, 2013); IEEE 802.11ad (“IEEE P802.11ad-2012, IEEE Standard for Information Technology—Telecommunications and Information Exchange Between Systems—Local and Metropolitan Area Networks—Specific Requirements—Part 11: Wireless LAN Medium Access Control (MAC) and Physical Layer (PHY) Specifications—Amendment 3: Enhancements for Very High Throughput in the 60 GHz Band”, 28 Dec., 2012); 802.11x) and/or future versions and/or derivatives thereof, devices and/or networks operating in accordance with existing Wireless Fidelity (WiFi) Alliance (WFA) Peer-to-Peer (P2P) specifications (WiFi P2P technical specification, version 1.2, 2012) and/or future versions and/or derivatives thereof, devices and/or networks operating in accordance with existing cellular specifications and/or protocols, e.g., 3rd Generation Partnership Project (3GPP), 3GPP Long Term Evolution (LTE) and/or future versions and/or derivatives thereof, devices and/or networks operating in accordance with existing WirelessHD™ specifications and/or future versions and/or derivatives thereof, units and/or devices which are part of the above networks, devices and/or networks operating in accordance with existing Intel Wireless Display (WiDi) specifications and/or future versions and/or derivatives thereof, devices and/or networks operating in accordance with existing Miracast™ specifications and/or future versions and/or derivatives thereof, units and/or devices which are part of the above networks, and the like.

Some embodiments may be used in conjunction with one way and/or two-way radio communication systems, a Miracast Device, a WiDi device, a Miracast sink, a Miracast source, a wireless display device, a video source, cellular radio-telephone communication systems, a mobile phone, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device, e.g., a Smartphone, a Wireless Application Protocol (WAP) device, or the like.

Some embodiments may be used in conjunction with one or more types of wireless communication signals and/or systems, for example, Radio Frequency (RF), Infra Red (IR), Frequency-Division Multiplexing (FDM), Orthogonal FDM (OFDM), Orthogonal Frequency-Division Multiple Access (OFDMA), FDM Time-Division Multiplexing (TDM), Time-Division Multiple Access (TDMA), Multi-User MIMO (MU-MIMO), Spatial Division Multiple Access (SDMA), Extended TDMA (E-TDMA), General Packet Radio Service (GPRS), extended GPRS, Code-Division Multiple Access (CDMA), Wideband CDMA (WCDMA), CDMA 2000, single-carrier CDMA, multi-carrier CDMA, Multi-Carrier Modulation (MDM), Discrete Multi-Tone (DMT), Bluetooth®, Global Positioning System (GPS), Wi-Fi, Wi-Max, ZigBee™, Ultra-Wideband (UWB), Global System for Mobile communication (GSM), 2G, 2.5G, 3G, 3.5G, 4G, Fifth Generation (5G) mobile networks, 3GPP, Long Term Evolution (LTE), LTE advanced, Enhanced Data rates for GSM Evolution (EDGE), or the like. Other embodiments may be used in various other devices, systems and/or networks.

The term “wireless device”, as used herein, includes, for example, a device capable of wireless communication, a communication device capable of wireless communication, a communication station capable of wireless communication, a portable or non-portable device capable of wireless communication, or the like. In some demonstrative embodiments, a wireless device may be or may include a peripheral that is integrated with a computer, or a peripheral that is attached to a computer. In some demonstrative embodiments, the term “wireless device” may optionally include a wireless service.

The term “communicating” as used herein with respect to a communication signal includes transmitting the communication signal and/or receiving the communication signal. For example, a communication unit, which is capable of communicating a communication signal, may include a transmitter to transmit the communication signal to at least one other communication unit, and/or a communication receiver to receive the communication signal from at least one other communication unit. The verb communicating may be used to refer to the action of transmitting or the action of receiving. In one example, the phrase “communicating a signal” may refer to the action of transmitting the signal by a first device, and may not necessarily include the action of receiving the signal by a second device. In another example, the phrase “communicating a signal” may refer to the action of receiving the signal by a first device, and may not necessarily include the action of transmitting the signal by a second device.

Some demonstrative embodiments may be used in conjunction with a WLAN. Other embodiments may be used in conjunction with any other suitable wireless communication network, for example, a wireless area network, a “piconet”, a WPAN, a WVAN and the like.

The term “antenna”, as used herein, may include any suitable configuration, structure and/or arrangement of one or more antenna elements, components, units, assemblies and/or arrays. In some embodiments, the antenna may implement transmit and receive functionalities using separate transmit and receive antenna elements. In some embodiments, the antenna may implement transmit and receive functionalities using common and/or integrated transmit/receive elements. The antenna may include, for example, a phased array antenna, a single element antenna, a set of switched beam antennas, and/or the like.

The term “station” (STA), as used herein, may include any logical entity that is at least one addressable instance of a medium access control (MAC) and a physical layer (PHY) interface to a wireless medium (WM).

The phrase “access point” (AP), as used herein, may include an entity that contains one station (STA) and provides access to distribution services, via the WM for associated STAs.

The phrase “non-access-point (non-AP) station (STA)”, as used herein, may relate to a STA that is not contained within an AP.

The phrase “peer to peer (PTP or P2P”), as used herein, may relate to device-to-device communication over a wireless link (“peer-to-peer link”) between a pair of devices. The P2P may include, for example, wireless communication over a direct link within a QoS basic service set (BSS), a tunneled direct-link setup (TDLS) link, a STA-to-STA communication in an independent basic service set (IBSS), or the like.

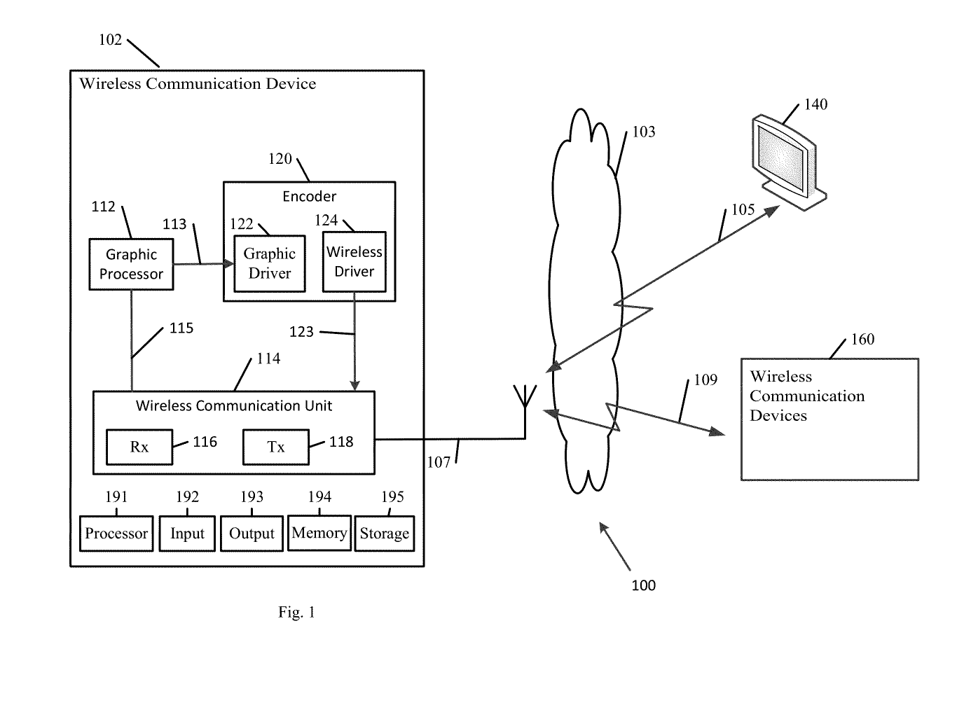

Reference is now made to FIG. 1, which schematically illustrates a block diagram of a system 100, in accordance with some demonstrative embodiments.

As shown in FIG. 1, in some demonstrative embodiments, system 100 may include one or more wireless communication devices capable of communicating content, data, information, audio, video, and/or signals via a wireless medium (WM) 103. For example, system 100 may include a wireless communication device 102.

In some demonstrative embodiments, device 102 may include a mobile or portable device.

In other embodiments, device 102 may include a non-mobile or a static device.

In some demonstrative embodiments, wireless communication device 102, may include, for example, a PC, a desktop computer, a mobile computer, a laptop computer, a User Equipment (UE), an Internet of Things (IoT) device, a notebook computer, a tablet computer, an Ultrabook™ computer, a mobile internet device, a server computer, a handheld computer, a handheld device, a PDA device, a handheld PDA device, an on-board device, an off-board device, a hybrid device (e.g., combining cellular phone functionalities with PDA device functionalities), a consumer device, a vehicular device, a non-vehicular device, a mobile or portable device, a non-mobile or non-portable device, a mobile phone, a cellular telephone, a PCS device, a PDA device which incorporates a wireless communication device, a mobile or portable GPS device, a DVB device, a relatively small computing device, a non-desktop computer, a “Carry Small Live Large” (CSLL) device, an Ultra Mobile Device (UMD), an Ultra Mobile PC (UMPC), a Mobile Internet Device (MID), an “Origami” device or computing device, a device that supports Dynamically Composable Computing (DCC), a context-aware device, a video device, an audio device, an A/V device, a Set-Top-Box (STB), a Blu-ray disc (BD) player, a BD recorder, a Digital Video Disc (DVD) player, a High Definition (HD) DVD player, a DVD recorder, a HD DVD recorder, a Personal Video Recorder (PVR), a broadcast HD receiver, a video source, a video sink, a stereo tuner, a flat panel display, a Personal Media Player (PMP), a digital video camera (DVC), a gaming device, a Digital Still camera (DSC), a media player, a Smartphone, a television, or the like.

In some demonstrative embodiments, device 102 may also include, for example, a processor 191, an input unit 192, an output unit 193, a memory unit 194, and a storage unit 195. Device 102 may optionally include other suitable hardware components and/or software components. In some demonstrative embodiments, some or all of the components of device 102 may be enclosed in a common housing or packaging, and may be interconnected or operably associated using one or more wired or wireless links. In other embodiments, components of device 102 may be distributed among multiple or separate devices.

Processor 191 include, for example, a Central Processing Unit (CPU), a Digital Signal Processor (DSP), one or more processor cores, a single-core processor, a dual-core processor, a multiple-core processor, a microprocessor, a host processor, a controller, a plurality of processors or controllers, a chip, a microchip, one or more circuits, circuitry, a logic unit, an Integrated Circuit (IC), an Application-Specific IC (ASIC), or any other suitable multi-purpose or specific processor or controller. For example, processor 191 executes instructions, for example, of an Operating System (OS) of device 102 and/or of one or more suitable applications.

Memory unit 194 includes, for example, a Random Access Memory (RAM), a Read Only Memory (ROM), a Dynamic RAM (DRAM), a Synchronous DRAM (SD-RAM), a flash memory, a volatile memory, a non-volatile memory, a cache memory, a buffer, a short term memory unit, a long term memory unit, or other suitable memory units. Storage unit 195 include, for example, a hard disk drive, a floppy disk drive, a Compact Disk (CD) drive, a CD-ROM drive, a DVD drive, or other suitable removable or non-removable storage units. For example, memory unit 194 and/or storage unit 195, for example, may store data processed by device 102.

Input unit 192 includes, for example, a keyboard, a keypad, a mouse, a touch-screen, a touch-pad, a track-ball, a stylus, a microphone, or other suitable pointing device or input device. Output unit 193 includes, for example, a monitor, a screen, a touch-screen, a flat panel display, a Light Emitting Diode (LED) display, a Liquid Crystal Display (LCD) display unit, a plasma display unit, one or more audio speakers or earphones, or other suitable output devices.

In some demonstrative embodiments, device 102 may be configured to stream media content from device 102 to a wireless display 140.

In some demonstrative embodiments, wireless display 140 may include a display device capable of outputting media content, for example, displaying video and/or to sound audio. For example, wireless display 140 may include a LED TV, a remote screen, a remote computer having a display, and/or the like.

Some demonstrative embodiments are described herein with respect to processing and/or streaming video content. Other embodiments may be implemented with respect to processing and/or streaming any other media content, e.g., audio content, graphic content, image content, and the like.

In some demonstrative embodiments, device 102 may stream the media content from device 102 via a wireless communication channel 105 over WM 103.

In some demonstrative embodiments, wireless communication channel 105 may include, for example, a wireless display channel, a Miracast channel, a WiDi channel, a Peer to Peer (P2P) channel, a WiFi channel, or any other channel configured to stream media content.

In some demonstrative embodiments, device 102 may be configured to communicate with one or more wireless communication devices 160.

In one example, device 102 may communicate with wireless communication devices 160 to receive and/or to gain access to one or more services, network resources, and/or applications, e.g., the Internet and/or any other applications.

In some demonstrative embodiments, wireless communication devices 160 may include an AP, a router, a server, and/or any other wireless communication device.

In some demonstrative embodiments, device 102 may communicate with wireless communication devices 160 via a wireless communication channel 109 over WM 103.

In some demonstrative embodiments, wireless communication channel 109 may include, for example, a WLAN channel, a P2P channel and/or any other channel configured to communicate with devices 160.

In some demonstrative embodiments, device 102 may include a wireless communication unit 114 to stream the media content from device 102 and wireless display 140; and/or to communicate between device 102 and wireless communication devices 160.

In one example, wireless communication unit 114 may stream the media content from device 102 to device 140 via wireless communication channel 105, e.g., to display the media content on wireless display 140.

In another example, wireless communication unit 114 may communicate with wireless communication devices 160 via wireless communication channel 109, e.g., to provide the Internet connectivity to device 102.

In some demonstrative embodiments, wireless communication unit 114 may include one or more wireless receivers (Rx) to receive wireless communication signals, RF signals, frames, blocks, transmission streams, packets, messages, data items, and/or data. For example, wireless communication unit 114 may include a receiver 116.

In some demonstrative embodiments, wireless communication unit 114 may include one or more wireless transmitters (Tx) to send wireless communication signals, RF signals, frames, blocks, transmission streams, packets, messages, data items, and/or data. For example, wireless communication unit 114 may include a transmitter 118.

In some demonstrative embodiments, wireless communication unit 114 may include modulation elements, demodulation elements, amplifiers, analog to digital and digital to analog converters, filters, and/or the like. For example, wireless communication unit 114 may include or may be implemented as part of a wireless Network Interface Card (NIC), and the like.

In some demonstrative embodiments, wireless communication unit 114 may include, or may be associated with, one or more antennas 107.

In one example, device 102 may include a single antenna 107. In other example, device 102 may include two or more antennas 107.

Antennas 107 may include any type of antennas suitable for transmitting and/or receiving wireless communication signals, blocks, frames, transmission streams, packets, messages and/or data. For example, antennas 107 may include any suitable configuration, structure and/or arrangement of one or more antenna elements, components, units, assemblies and/or arrays. Antennas 107 may include, for example, antennas suitable for directional communication, e.g., using beamforming techniques. For example, antennas 107 may include a phased array antenna, a multiple element antenna, a set of switched beam antennas, and/or the like. In some embodiments, antennas 107 may implement transmit and receive functionalities using separate transmit and receive antenna elements. In some embodiments, antennas 107 may implement transmit and receive functionalities using common and/or integrated transmit/receive elements.

In some demonstrative embodiments, device 102 may include a graphic processor 112 to provide a video stream 113 to be transmitted to wireless display 140, e.g., via wireless communication channel 105.

In some demonstrative embodiments, graphic processor 112 may include logic and/or circuitry, e.g., processor circuitry, memory circuitry, and/or any other circuitry, configured to perform the functionality of graphic processor 112. Additionally or alternatively, one or more functionalities of graphic processor 112 may be implemented by logic, which may be executed by a machine and/or one or more processors, e.g., as described below.

In some demonstrative embodiments, graphic processor 112 may be implemented as part of processor 191. In other embodiments, graphic processor 112 may be implemented as an element of device 102.

In some demonstrative embodiments, device 102 may include an encoder 120 configured to receive video stream 113, e.g., from graphic processor 112.

In some demonstrative embodiments, encoder 120 may include circuitry, e.g., processor circuitry, memory circuitry, and/or any other circuitry, configured to perform the functionality of encoder 120. Additionally or alternatively, one or more functionalities of encoder 120 may be implemented by logic, which may be executed by a machine and/or one or more processors, e.g., as described below.

In some demonstrative embodiments, encoder 120 may be configured to encode video stream 113 into an encoded video stream 123.

In some demonstrative embodiments, encoder 120 may be configured to send encoded video stream 123 to wireless communication unit 114.

In some demonstrative embodiments, encoder 120 may include a graphic driver 122 of graphic processor 112.

In some demonstrative embodiments, graphic driver 122 may be configured to receive video stream 113, e.g., from graphic processor 112.

In some demonstrative embodiments, encoder 120 may include a wireless driver 124 of wireless communication unit 114.

In some demonstrative embodiments, wireless driver 124 may be configured to send video stream 123, e.g., to wireless communication unit 114.

In some demonstrative embodiments, encoder 120 may be implemented as part of graphic processor 112. In other embodiments, encoder 120 may be implemented as another element of device 102.

In some demonstrative embodiments, wireless communication unit 114 may receive encoded video stream 123, and may transmit encoded video stream 123 to wireless display 140.

In some demonstrative embodiments, wireless communication unit 114 may stream the encoded video stream 123 to wireless display 140 (“the video streaming”) and may communicate with wireless communication devices 160 (“the other wireless communication”) during at least partially overlapping time periods.

In some demonstrative embodiments, providing the video streaming and the other wireless communication at the same time may reduce the quality of video and/or audio encoded in video stream 123, for example, if the video streaming and the wireless communication are not synchronized.

In some demonstrative embodiments, providing the video streaming and the wireless communication at the same time may increase latency and/or may reduce reliability of the video and/or the audio received by wireless display 140 (“the received media content”), for example, if the video streaming and the wireless communication are not synchronized.

In some demonstrative embodiments, the increase in the latency and/or the reduced reliability of the received media content may reduce usability of video streaming to wireless display 140.

In some demonstrative embodiments, the latency of the received media content may increase, for example, if the video streaming and the wireless communication uses different channels, e.g., wireless communication channels 105 and 109.

In one example, the latency of the received media content may increase, for example, due to time periods, required for channel switching between wireless communication channels 105 and 109.

In some demonstrative embodiments, reducing the latency of the received media content, for example, by reducing the resolution of the video and/or the audio, and/or changing an encoding algorithm of the video and/or the video, may reduce the quality of the received media content.

Some demonstrative embodiments may enable to synchronize the video streaming with the other wireless communication, for example, without reducing the quality of the audio and/or the received media content, e.g., as described below.

In some demonstrative embodiments, encoded video stream 123 may be transmitted to wireless display 140 in a burst.

In some demonstrative embodiments, the burst may include a transmission having a high video and/or audio rate, and/or a large amount of data at a short period.

In some demonstrative embodiments, the burst may be an internal event and may be based, for example, on an internal timer of graphic processor 112.

In one example, graphic processor 112 may initiate the burst, for example, when an image on wireless display 140 refreshes.

In some demonstrative embodiments, wireless communication unit 114 may be configured to receive a burst start indication that encoded video stream 123 is to be streamed in a burst.

In some demonstrative embodiments, the burst start indication may enable wireless communication unit 114 to stream encoded video stream 123 to wireless display 140, for example, while reducing an impact on the other wireless communication, e.g., as described below.

In some demonstrative embodiments, the burst start indication may enable wireless communication unit 114 to be prepared for the burst and to transmit encoded video stream 123 to wireless display 140 at a reduced latency.

In some demonstrative embodiments, wireless communication unit 114 may receive the burst start indication that encoded video stream 123 is to be streamed in a burst.

In some demonstrative embodiments, the burst start indication may be sent from one or more elements of device 102, for example, encoder 120, and/or graphic processor 112, e.g., as described below.

In some demonstrative embodiments, wireless communication unit 114 may receive encoded video stream 123 from encoder 120.

In some demonstrative embodiments, based on the burst start indication, wireless communication unit 114 may transmit encoded video stream 123 to wireless display 140.

In some demonstrative embodiments, based on the burst start indication, wireless communication unit 114 may switch between wireless communication channel 109, e.g., to communicate with devices 160, and wireless communication channel 105, e.g., to communicate with wireless display 140.

In one example, wireless communication unit 114 may switch from wireless communication channel 109 to wireless communication channel 105, for example, after the receipt of the burst start indication.

In some demonstrative embodiments, wireless communication unit 114 may receive a burst end indication to indicate an end of the encoded video stream 123.

In some demonstrative embodiments, based on the burst end indication, wireless communication unit 114 may switch between wireless communication channel 109 and wireless communication channel 105.

In one example, wireless communication unit 114 may switch from wireless communication channel 105 to wireless communication channel 109, for example, after the receipt of the burst end indication.

In some demonstrative embodiments, wireless communication unit 114 may receive the burst start indication a predefined time period before the reception of encoded video stream 123.

In some demonstrative embodiments, wireless communication unit 114 may provide a duration of the predefined time period to a sender of the burst start indication.

In one example, the duration of the predefined time period may be based, for example, on a time period, which is to be used by wireless communication unit 114 to switch to wireless communication channel 109.

In some demonstrative embodiments, the burst start indication may include a duration of the burst.

In some demonstrative embodiments, the burst start indication may include a data size of the burst.

In some demonstrative embodiments, the duration and the data size of the burst may enable wireless communication unit 114 to be prepared to transmit encoded video stream 123, e.g., to prepare and/or to reserve one or more network resources to stream encoded video stream 123 to wireless display 140.

In some demonstrative embodiments, based on the burst start indication, wireless communication unit 114 may switch between wireless communication channel 109, e.g., to communicate with devices 160, and wireless communication channel 105, e.g., to communicate with wireless display 140.

In some demonstrative embodiments, wireless communication unit 114 may be configured to receive the burst start indication in one or more forms, e.g., as described below.

In some demonstrative embodiments, wireless communication unit 114 may be configured to receive the burst start indication via a physical connection between wireless communication unit 114 and graphic processor 112, e.g., as described below.

In some demonstrative embodiments, device 102 may include a wired link 115 between wireless communication unit 114 and graphic processor 112.

In some demonstrative embodiments, wired link 115 may include an external wire between wireless communication unit 114 and graphic processor 112, for example, if wireless communication unit 114 and graphic processor 112 are separate elements of device 102.

In some demonstrative embodiments, wired link 115 may include an internal line and/or between wireless communication unit 114 and graphic processor 112, for example, if wireless communication unit 114 and graphic processor 112 are implemented by a single element, e.g., an Application-Specific Integrated Circuit (ASIC).

In some demonstrative embodiments, wireless communication unit 114 may receive the burst start indication via wired link 115.

In some demonstrative embodiments, graphic processor 112 may send the burst start indication via wired link 115.

In some demonstrative embodiments, graphic processor 112 may send the burst start indication a predefined time period before sending video stream 113 to encoder 120.

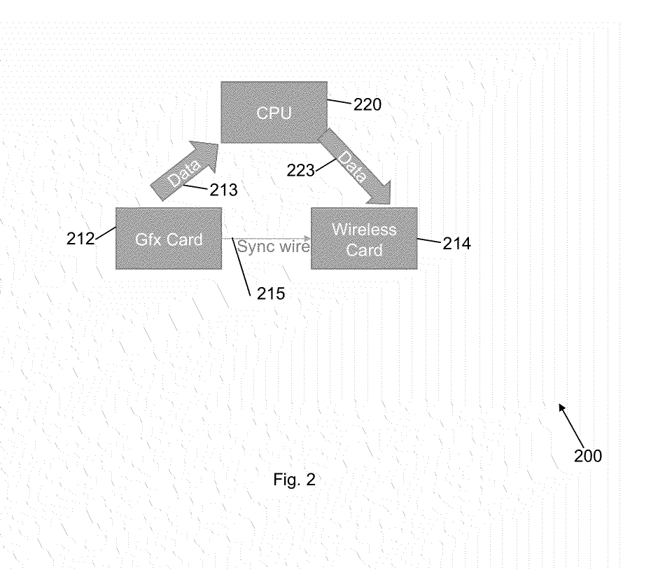

In some demonstrative embodiments, wireless communication unit 114 may receive the burst start indication from graphic processor 112, may receive encoded video stream 123 from encoder 120, and may transmit encoded video stream 123 to wireless display 140 via wireless communication channel 105, e.g., as described below with reference to FIG. 2.

Reference is made to FIG. 2, which schematically illustrates a block diagram of a processing scheme 200 to transmit media content, in accordance with some demonstrative embodiments.

As shown in FIG. 2, system 200 may include a Central Processing Unit (CPU) 220, a graphic processor 212, and/or a wireless communication unit 214. For example, CPU 220 may perform the functionality of encoder 120 (FIG. 1), graphic processor 212 may perform the functionality of graphic processor 112 (FIG. 1), and/or wireless communication unit 214 may perform the functionality of wireless communication unit 114 (FIG. 1).

As shown in FIG. 2, graphic processor 212 may send video stream 213 to CPU 220, and CPU 220 may send encoded video stream 223 to wireless communication unit 214. For example, video stream 213 may perform the functionality of video stream 113 (FIG. 1), and/or encoded video stream 223 may perform the functionality of encoded video stream 123 (FIG. 1).

As shown in FIG. 2, a wired link 215 may physically connect between graphic processor 212 and wireless communication unit 214 to enable wireless communication unit 214 to receive the burst start indication from graphic processor 212. For example, wired link 215 may perform the functionality of wired link 115 (FIG. 1).

Referring back to FIG. 1, in some demonstrative embodiments, wireless communication unit 114 may be configured to receive the burst start indication via a software interface between wireless communication unit 114, graphic processor 112, and encoder 120, e.g., as described below.

In some demonstrative embodiments, graphic processor 112 may interrupt graphic driver 122, e.g., to indicate that encoded video stream 123 is to be transmitted in a burst.

In some demonstrative embodiments, graphic driver 122 may notify wireless driver 124 that encoded video stream 123 is to be transmitted in a burst.

In some demonstrative embodiments, wireless driver 124 may prepare wireless communication unit 114 to transmit encoded video stream 123 in a burst.

In some demonstrative embodiments, wireless communication unit 114 may receive the burst start indication via wireless driver 124.

In some demonstrative embodiments, graphic processor 112 may interrupt graphic driver 122 a predefined time period before sending video stream 113 to encoder 120.

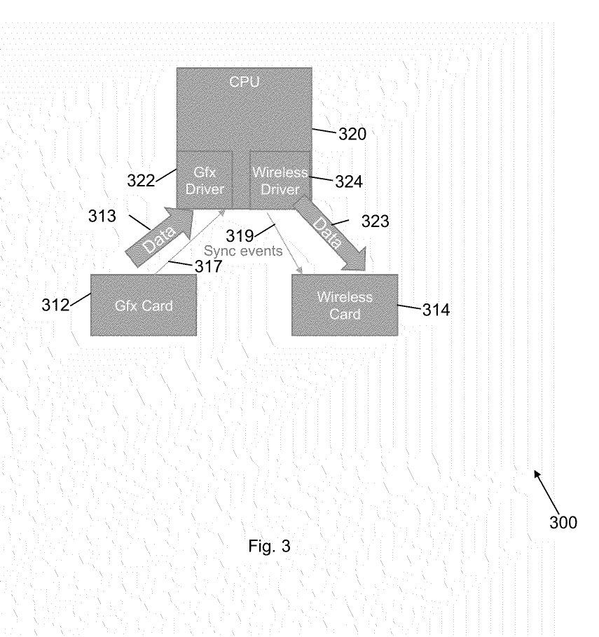

In some demonstrative embodiments, wireless communication unit 114 may receive the burst start indication from wireless driver 124, may receive encoded video stream 123 from encoder 120, and may transmit encoded video stream 123 to wireless display 140 via wireless communication channel 105, e.g., as described below with reference to FIG. 3.

Reference is made to FIG. 3, which schematically illustrates a block diagram of a processing scheme 300 to transmit media content, in accordance with some demonstrative embodiments.

As shown in FIG. 3, system 300 may include a Central Processing Unit (CPU) 320, a graphic processor 312, and/or a wireless communication unit 314. For example, CPU 320 may perform the functionality of encoder 120 (FIG. 1), graphic processor 312 may perform the functionality of graphic processor 112 (FIG. 1), and/or wireless communication unit 314 may perform the functionality of wireless communication unit 114 (FIG. 1).

As shown in FIG. 3, graphic processor 312 may send video stream 313 to CPU 320, and CPU 320 may send encoded video stream 323 to wireless communication unit 314. For example, video stream 313 may perform the functionality of video stream 113 (FIG. 1), and/or encoded video stream 323 may perform the functionality of encoded video stream 123 (FIG. 1).

As shown in FIG. 3, encoder 320 may include a graphic driver 322 to receive video stream 313, and to receive from graphic processor 312 an interrupt 317 to indicate that video stream 313 is to be transmitted in a burst. For example, graphic driver 322 may perform the functionality of graphic driver 122 (FIG. 1).

As shown in FIG. 3, encoder 320 may include a wireless driver 324 to send encoded video stream 323, and to send to wireless communication unit 314 a sync event 319 to prepare wireless communication unit 314 to transmit encoded video stream 323 in a burst. For example, wireless driver 324 may perform the functionality of wireless driver 124 (FIG. 1).

Referring back to FIG. 1, in some demonstrative embodiments, wireless communication unit 114 may be configured to receive the burst start indication as part of encoded video stream 123, e.g., as described below.

In some demonstrative embodiments, the burst start indication may be embedded in encoded video stream 123.

In one example, one or more frames and/or packets of encoded video stream 123 may include one or more indications, e.g., in the form of one or more dedicated frames, to indicate that that encoded video stream 123 is to be transmitted in a burst.

In some demonstrative embodiments, wireless communication unit 114 may be configured to tolerate a minimal delay to transmit encoded video stream 123, for example, if the burst start indication is embedded in encoded video stream 123.

In some demonstrative embodiments, graphic processor 112 may embed the burst start indication in one or more frames of video stream 113, and/or encoder 120 may embed the burst start indication in one or more frames of encoded video stream 123.

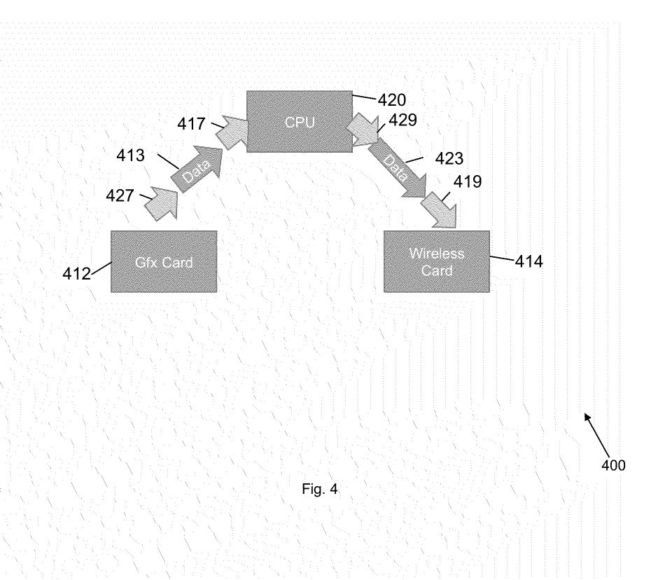

In some demonstrative embodiments, wireless communication unit 114 may receive the burst start indication in the one or more frames of encoded video stream 123, and may transmit encoded video stream 123 to wireless display 140 via wireless communication channel 105, e.g., as described below with reference to FIG. 4.

Reference is made to FIG. 4, which schematically illustrates a block diagram of a processing scheme 400 to transmit media content, in accordance with some demonstrative embodiments.

As shown in FIG. 4, system 400 may include a Central Processing Unit (CPU) 420, a graphic processor 412, and/or a wireless communication unit 414. For example, CPU 420 may perform the functionality of encoder 120 (FIG. 1), graphic processor 412 may perform the functionality of graphic processor 112 (FIG. 1), and/or wireless communication unit 414 may perform the functionality of wireless communication unit 114 (FIG. 1).

As shown in FIG. 4, graphic processor 412 may send video stream 413 to CPU 420, and CPU 420 may send encoded video stream 423 to wireless communication unit 414. For example, video stream 413 may perform the functionality of video stream 113 (FIG. 1), and/or encoded video stream 423 may perform the functionality of encoded video stream 123 (FIG. 1).

As shown in FIG. 4, graphic processor 412 may embed the burst start indication in one or more frames 417 of video stream 413, and/or encoder 420 may embed the burst start indication in one or more frames 419 of encoded video stream 423.

As shown in FIG. 4, graphic processor 412 may embed the burst end indication in one or more frames 427 of video stream 413, and/or encoder 420 may embed the burst end indication in one or more frames 429 of encoded video stream 423.

Referring back To FIG. 1, in some demonstrative embodiments, wireless communication unit 114 may cancel a transmission of a previous encoded video stream, e.g., prior to encoded video stream 123, to be transmitted in a burst, for example, if wireless communication unit 114 receives the burst start indication and the previous encoded video stream is not transmitted.

In some demonstrative embodiments, indicating to wireless communication unit 114 that encoded video stream 123 is to be streamed in a burst may improve quality of the received media content from device 102, may reduce latency of the received media content and/or may increase usability of the media content streamed to wireless display 140.

In some demonstrative embodiments, wireless communication unit 114 may be configured to cancel a transmission of first encoded video stream, for example, wireless communication unit receives the bust start indication corresponding to a second encoded video stream, e.g., subsequent to the first encoded video stream, for example, if the first encoded video stream has not yet been transmitted.

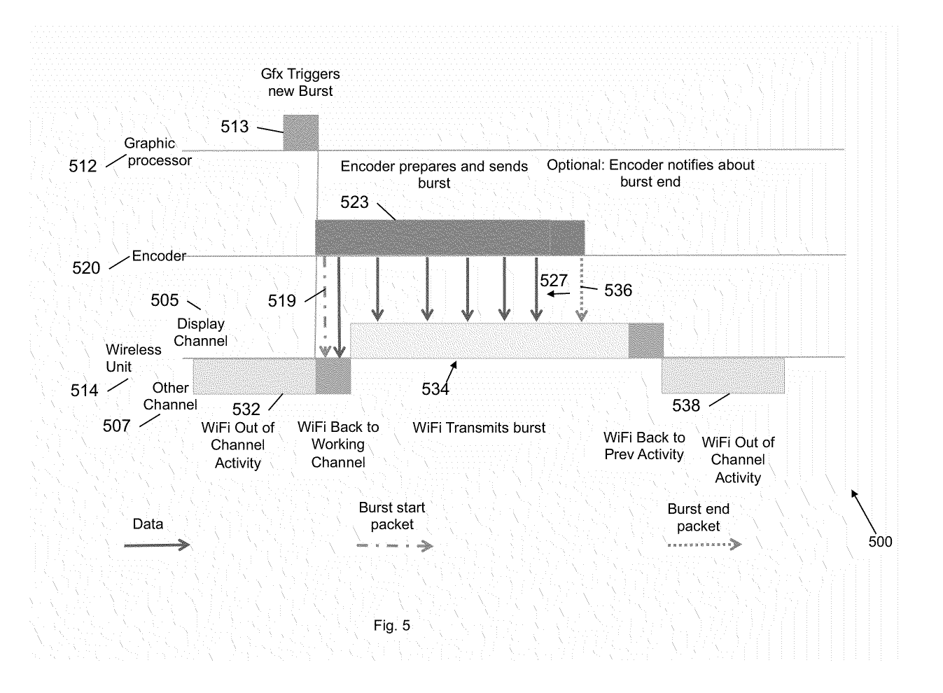

Reference is made to FIG. 5, which schematically illustrates a sequence diagram 500, which demonstrates operations and interactions between an Encoder 520, a graphic processor 512, and/or a wireless communication unit 514 for media streaming. For example, encoder 520 may perform the functionality of encoder 120 (FIG. 1), graphic processor 512 may perform the functionality of graphic processor 112 (FIG. 1), and/or wireless communication unit 514 may perform the functionality of wireless communication unit 114 (FIG. 1).

As shown in FIG. 5, graphic processor 512 may provide a media content, e.g., a video stream 513, to be transmitted as a burst. For example, graphic processor 112 (FIG. 1) may provide video stream 113 (FIG. 1), e.g., as described above.

As shown in FIG. 5, encoder 520 may receive video stream 513, may encode video stream 513 into an encoded video stream 523, and may send (527) encoded video stream 523 to wireless communication unit 514. For example, encoder 120 (FIG. 1) may receive video stream 113 (FIG. 1), may encode video stream 113 (FIG. 1) into encoded video stream 123 (FIG. 1), and may send encoded video stream 123 (FIG. 1) to wireless communication unit 114 (FIG. 1), e.g., as described above.

As shown in FIG. 5, wireless communication unit 514 may be configured to communicate over a display channel 505 and another wireless channel 507. For example, display channel 505 may perform the functionality of wireless communication channel 105 (FIG. 1), and/or wireless channel 507 may perform the functionality of wireless communication channel 109 (FIG. 1), e.g., as described above.

As shown in FIG. 5, wireless communication unit 514 may communicate data 532 over wireless channel 507. For example, wireless communication unit 114 (FIG. 1) may communicate with wireless communication devices 160 (FIG. 1) over wireless communication channel 109 (FIG. 1), e.g., as described below.

As shown in FIG. 5, encoder 520 may send to wireless communication unit 514 an indication 519 that encoded video stream 523 is to be transmitted in a burst. For example, encoder 120 (FIG. 1) may send the burst start indication to wireless communication unit 114 (FIG. 1), e.g., as described above.

As shown in FIG. 5, wireless communication unit 514 may receive indication 519, may prepare to transmit encoded video stream 523 in a burst, and may switch to display channel 505 to transmit (534) encoded video stream 523 in a burst. For example, wireless communication unit 114 (FIG. 1) may switch from wireless communication channel 109 (FIG. 1) to wireless communication channel 105 (FIG. 1) to transmit encoded video stream 123 (FIG. 1) in a burst, e.g., as described above.

As shown in FIG. 5, optionally, encoder 520 may send an end indication 536 to notify wireless communication unit 514 at an end of encoded video stream 523. For example, encoder 120 (FIG. 1) may send the burst end indication to wireless communication unit 114 (FIG. 1), e.g., as described above.

As shown in FIG. 5, wireless communication unit 514 may receive end indication 536 and may switch back to wireless channel 507 to communicate (538) over wireless communication channel 507. For example, wireless communication unit 114 (FIG. 1) may switch from wireless communication channel 105 (FIG. 1) to wireless communication channel 109 (FIG. 1) to communicate with wireless communication devices 160 (FIG. 1), e.g., as described above.

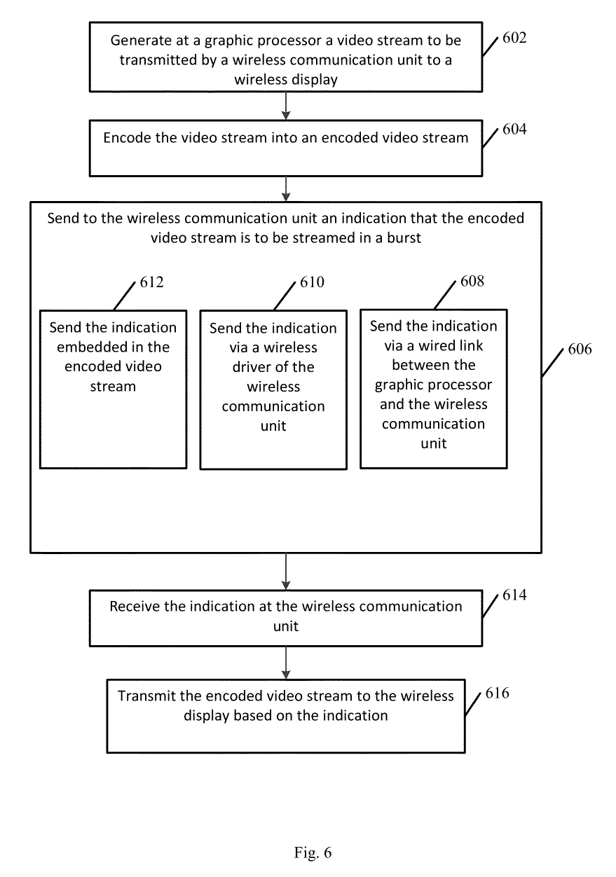

Reference is now made to FIG. 6, which schematically illustrates a method of media streaming, in accordance with some demonstrative embodiments. For example, one or more of the operations of the method of FIG. 6 may be performed by a wireless communication system, e.g., system 100 (FIG. 1); a wireless communication device, e.g., device 102 (FIG. 1), a wireless communication unit, e.g., wireless communication unit 114 (FIG. 1); a graphic processor, e.g., graphic processor 112 (FIG. 1); and/or an encoder, e.g., encoder 120 (FIG. 1).

As indicated at block 602, the method may include generating at a graphic processor a media content, e.g., a video stream, to be transmitted by a wireless communication unit to a wireless display. For example, graphic processor 112 (FIG. 1) may generate video stream 113 (FIG. 1) to be transmitted to wireless display 140 (FIG. 1), e.g., as described above.

As indicated at block 604, the method may include encoding the video stream into an encoded video stream. For example, encoder 120 (FIG. 1) may encode video stream 113 (FIG. 1) into encoded video stream 123 (FIG. 1), e.g., as described above.

As indicated at block 606, the method may include sending to the wireless communication unit an indication that the encoded video stream is to be streamed in a burst. For example, graphic processor 112 (FIG. 1) and/or encoder 120 (FIG. 1) may send the burst start indication to wireless communication unit 114 (FIG. 1) that encoded video stream 123 (FIG. 1) is to be streamed in a burst, e.g., as described above.

As indicated at block 608, sending the burst start indication may include sending the burst start indication via a wired link between the graphic processor and the wireless communication unit. For example, graphic processor 112 (FIG. 1) may send the burst start indication to wireless communication unit 114 (FIG. 1) via wired link 115 (FIG. 1), e.g., as described above.

As indicated at block 610, sending the burst start indication may include sending the burst start indication via a wireless driver of the wireless communication unit. For example, encoder 120 (FIG. 1) may send the burst start indication to wireless communication unit 114 (FIG. 1) via wireless driver 124 (FIG. 1), e.g., as described above.

As indicated at block 612, sending the burst start indication may include sending the burst start indication embedded in the encoded video stream. For example, encoder 120 (FIG. 1) may embed the burst start indication in encoded video stream 123 (FIG. 1), e.g., as described above.

As indicated at block 614, the method may include receiving the burst start indication at the wireless communication unit. For example, wireless communication unit 114 (FIG. 1) may receive the burst start indication, e.g., as described above.

As indicated at block 616, the method may include transmitting the encoded video stream to the wireless display based on the burst start indication. For example, wireless communication unit 114 (FIG. 1) may transmit encoded video stream 123 (FIG. 1) to wireless display 140 (FIG. 1) based on the burst start indication, e.g., as described above.

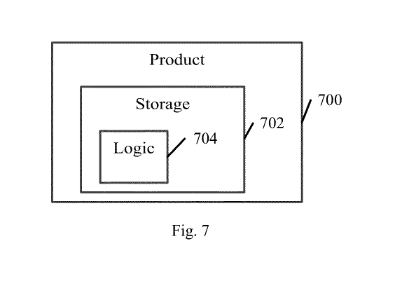

Reference is made to FIG. 7, which schematically illustrates a product of manufacture 700, in accordance with some demonstrative embodiments. Product 700 may include a non-transitory machine-readable storage medium 702 to store logic 704, which may be used, for example, to perform at least part of the functionality of device 102 (FIG. 1), wireless communication unit 114 (FIG. 1), graphic processor 112 (FIG. 1), encoder 120 (FIG. 1), and/or to perform one or more operations of the method of FIG. 6. The phrase “non-transitory machine-readable medium” is directed to include all computer-readable media, with the sole exception being a transitory propagating signal.

In some demonstrative embodiments, product 700 and/or machine-readable storage medium 702 may include one or more types of computer-readable storage media capable of storing data, including volatile memory, non-volatile memory, removable or non-removable memory, erasable or non-erasable memory, writeable or re-writeable memory, and the like. For example, machine-readable storage medium 702 may include, RAM, DRAM, Double-Data-Rate DRAM (DDR-DRAM), SDRAM, static RAM (SRAM), ROM, programmable ROM (PROM), erasable programmable ROM (EPROM), electrically erasable programmable ROM (EEPROM), Compact Disk ROM (CD-ROM), Compact Disk Recordable (CD-R), Compact Disk Rewriteable (CD-RW), flash memory (e.g., NOR or NAND flash memory), content addressable memory (CAM), polymer memory, phase-change memory, ferroelectric memory, silicon-oxide-nitride-oxide-silicon (SONOS) memory, a disk, a floppy disk, a hard drive, an optical disk, a magnetic disk, a card, a magnetic card, an optical card, a tape, a cassette, and the like. The computer-readable storage media may include any suitable media involved with downloading or transferring a computer program from a remote computer to a requesting computer carried by data signals embodied in a carrier wave or other propagation medium through a communication link, e.g., a modem, radio or network connection.

In some demonstrative embodiments, logic 704 may include instructions, data, and/or code, which, if executed by a machine, may cause the machine to perform a method, process and/or operations as described herein. The machine may include, for example, any suitable processing platform, computing platform, computing device, processing device, computing system, processing system, computer, processor, or the like, and may be implemented using any suitable combination of hardware, software, firmware, and the like.

In some demonstrative embodiments, logic 704 may include, or may be implemented as, software, a software module, an application, a program, a subroutine, instructions, an instruction set, computing code, words, values, symbols, and the like. The instructions may include any suitable type of code, such as source code, compiled code, interpreted code, executable code, static code, dynamic code, and the like. The instructions may be implemented according to a predefined computer language, manner or syntax, for instructing a processor to perform a certain function. The instructions may be implemented using any suitable high-level, low-level, object-oriented, visual, compiled and/or interpreted programming language, such as C, C++, Java, BASIC, Matlab, Pascal, Visual BASIC, assembly language, machine code, and the like.

### Examples

The following examples pertain to further embodiments.

Example 1 includes a wireless communication device comprising a wireless communication unit, including a transmitter and a receiver, to communicate with a wireless display; and a graphic processor to provide a video stream to be transmitted to the wireless display, to send to the wireless communication unit an indication that the video stream is to be streamed in a burst, and to send the video stream to the wireless communication unit.

Example 2 includes the subject matter of Example 1, and optionally, wherein the graphic processor is to send the indication via a wired link between the wireless communication unit and the graphic processor.

Example 3 includes the subject matter of Example 1 or 2, and optionally, comprising an encoder to encode the video stream into an encoded video stream, and to send the encoded video stream to the wireless communication unit.

Example 4 includes the subject matter of Example 3, and optionally, wherein the graphic processor is to send the indication via the encoder.

Example 5 includes the subject matter of Example 3 or 4, and optionally, wherein the indication is embedded in the encoded video stream.

Example 6 includes the subject matter of any one of Examples 1-5, and optionally, wherein the indication includes a duration of the burst, and a data size of the burst.

Example 7 includes the subject matter of any one of Examples 1-6, and optionally, wherein the graphic processor is to send the indication a predefined time period before sending the video stream to the wireless communication unit.

Example 8 includes the subject matter of any one of Examples 1-7, and optionally, wherein the graphic processor is to send to the wireless communication unit an end indication to indicate an end of the video stream.

Example 9 includes a graphic processing device comprising a graphic processor to provide a video stream to be transmitted to a wireless display via a wireless communication unit; and an encoder to encode the video stream into an encoded video stream, to send to the wireless communication unit an indication that the encoded video stream is to be streamed in a burst, and to send the encoded video stream to the wireless communication unit.

Example 10 includes the subject matter of Example 9, and optionally, wherein the indication is embedded in the encoded video stream.

Example 11 includes the subject matter of Example 9 or 10, and optionally, wherein the encoder includes a graphic driver of the graphic processor and a wireless driver of the wireless communication unit, the graphic driver to receive the video stream and a notification that the video stream is to be streamed in a burst, and the wireless driver is to send the encoded video stream and the indication.

Example 12 includes the subject matter of any one of Examples 9-11, and optionally, wherein the indication includes a duration of the burst, and a data size of the burst.

Example 13 includes the subject matter of any one of Examples 9-12, and optionally, wherein the encoder is to send the indication a predefined time period before sending the encoded video stream to the wireless communication unit.

Example 14 includes the subject matter of any one of Examples 9-13, and optionally, wherein the encoder is to send to the wireless communication unit an end indication to indicate an end of the encoded video stream.

Example 15 includes a wireless communication device comprising an encoder to receive from a graphic processor a video stream to be transmitted to a wireless display, and to encode the video stream into an encoded video stream; and a wireless communication unit to communicate with the wireless display, to receive an indication that the encoded video stream is to be streamed in a burst, to receive the encoded video stream from the encoder, and to transmit the encoded video stream to the wireless display based on the indication.

Example 16 includes the subject matter of Example 15, and optionally, wherein the wireless communication unit is to receive the indication from the graphic processor via a wired link between the wireless communication unit and the graphic processor.

Example 17 includes the subject matter of Example 15, and optionally, wherein the wireless communication unit is to receive the indication from the encoder.

Example 18 includes the subject matter of Example 17, and optionally, wherein the indication is embedded in the encoded video stream.

Example 19 includes the subject matter of any one of Examples 15-18, and optionally, wherein, based on the indication, the wireless communication unit is to switch between a first wireless communication channel to communicate with the display device, and a second wireless communication channel to communicate with one or more wireless communication devices.

Example 20 includes the subject matter of any one of Examples 15-19, and optionally, wherein the indication includes a duration of the burst, and a data size of the burst.

Example 21 includes the subject matter of any one of Examples 15-20, and optionally, wherein the wireless communication unit is to receive the indication a predefined time period before reception of the encoded video stream.

Example 22 includes the subject matter of Example 21, and optionally, wherein the wireless communication unit is to provide a duration of the predefined time period to the encoder.

Example 23 includes the subject matter of any one of Examples 15-22, and optionally, wherein the wireless communication unit is to receive an end indication to indicate an end of the video stream.

Example 24 includes a system including a wireless communication device, the wireless communication device comprising one or more antennas; a memory; a wireless communication unit, including a transmitter and a receiver, to communicate with a wireless display; and a graphic processor to provide a video stream to be transmitted to the wireless display, to send to the wireless communication unit an indication that the video stream is to be streamed in a burst, and to send the video stream to the wireless communication unit.

Example 25 includes the subject matter of Example 24, and optionally, wherein the graphic processor is to send the indication via a wired link between the wireless communication unit and the graphic processor.

Example 26 includes the subject matter of Example 24 or 25, and optionally, comprising an encoder to encode the video stream into an encoded video stream, and to send the encoded video stream to the wireless communication unit.

Example 27 includes the subject matter of Example 26, and optionally, wherein the graphic processor is to send the indication via the encoder.

Example 28 includes the subject matter of Example 26 or 27, and optionally, wherein the indication is embedded in the encoded video stream.

Example 29 includes the subject matter of any one of Examples 24-28, and optionally, wherein the indication includes a duration of the burst, and a data size of the burst.

Example 30 includes the subject matter of any one of Examples 24-29, and optionally, wherein the graphic processor is to send the indication a predefined time period before sending the video stream to the wireless communication unit.

Example 31 includes the subject matter of any one of Examples 24-30, and optionally, wherein the graphic processor is to send to the wireless communication unit an end indication to indicate an end of the video stream.

Example 32 includes a system including a graphic processing device, the wireless communication device comprising one or more antennas; a memory; a graphic processor to provide a video stream to be transmitted to a wireless display via a wireless communication unit; and an encoder to encode the video stream into an encoded video stream, to send to the wireless communication unit an indication that the encoded video stream is to be streamed in a burst, and to send the encoded video stream to the wireless communication unit.

Example 33 includes the subject matter of Example 32, and optionally, wherein the indication is embedded in the encoded video stream.

Example 34 includes the subject matter of Example 32 or 33, and optionally, wherein the encoder includes a graphic driver of the graphic processor and a wireless driver of the wireless communication unit, the graphic driver to receive the video stream and a notification that the video stream is to be streamed in a burst, and the wireless driver is to send the encoded video stream and the indication.

Example 35 includes the subject matter of any one of Examples 32-34, and optionally, wherein the indication includes a duration of the burst, and a data size of the burst.

Example 36 includes the subject matter of any one of Examples 32-35, and optionally, wherein the encoder is to send the indication a predefined time period before sending the encoded video stream to the wireless communication unit.

Example 37 includes the subject matter of any one of Examples 32-36, and optionally, wherein the encoder is to send to the wireless communication unit an end indication to indicate an end of the encoded video stream.

Example 38 includes a system including a wireless communication device, the wireless communication device comprising one or more antennas; a memory; an encoder to receive from a graphic processor a video stream to be transmitted to a wireless display, and to encode the video stream into an encoded video stream; and a wireless communication unit to communicate with the wireless display, to receive an indication that the encoded video stream is to be streamed in a burst, to receive the encoded video stream from the encoder, and to transmit the encoded video stream to the wireless display based on the indication.

Example 39 includes the subject matter of Example 38, and optionally, wherein the wireless communication unit is to receive the indication from the graphic processor via a wired link between the wireless communication unit and the graphic processor.

Example 40 includes the subject matter of Example 38, and optionally, wherein the wireless communication unit is to receive the indication from the encoder.

Example 41 includes the subject matter of Example 40, and optionally, wherein the indication is embedded in the encoded video stream.

Example 42 includes the subject matter of any one of Examples 38-41, and optionally, wherein, based on the indication, the wireless communication unit is to switch between a first wireless communication channel to communicate with the display device, and a second wireless communication channel to communicate with one or more wireless communication devices.

Example 43 includes the subject matter of any one of Examples 38-42, and optionally, wherein the indication includes a duration of the burst, and a data size of the burst.

Example 44 includes the subject matter of any one of Examples 38-43, and optionally, wherein the wireless communication unit is to receive the indication a predefined time period before reception of the encoded video stream.

Example 45 includes the subject matter of Example 44, and optionally, wherein the wireless communication unit is to provide a duration of the predefined time period to the encoder.

Example 46 includes the subject matter of any one of Examples 38-45, and optionally, wherein the wireless communication unit is to receive an end indication to indicate an end of the video stream.

Example 47 includes a method to be performed at a wireless communication device, the method comprising generating a video stream to be transmitted by a wireless communication unit to a wireless display; sending to the wireless communication unit an indication that the video stream is to be streamed in a burst; and sending the video stream to the wireless communication unit.

Example 48 includes the subject matter of Example 47, and optionally, comprising sending the indication via a wired link between the wireless communication unit and a graphic processor.

Example 49 includes the subject matter of Example 47 or 48, and optionally, comprising encoding the video stream into an encoded video stream, and sending the encoded video stream to the wireless communication unit.

Example 50 includes the subject matter of Example 49, and optionally, comprising sending the indication via an encoder.

Example 51 includes the subject matter of Example 49 or 50, and optionally, wherein the indication is embedded in the encoded video stream.

Example 52 includes the subject matter of any one of Examples 47-51, and optionally, wherein the indication includes a duration of the burst, and a data size of the burst.

Example 53 includes the subject matter of any one of Examples 47-52, and optionally, comprising sending the indication a predefined time period before sending the video stream to the wireless communication unit.

Example 54 includes the subject matter of any one of Examples 47-53, and optionally, comprising sending to the wireless communication unit an end indication to indicate an end of the video stream.

Example 55 includes a method to be performed at a graphic processing device, the method comprising generating a video stream to be transmitted by a wireless communication unit to a wireless display; encoding the video stream into an encoded video stream; sending to the wireless communication unit an indication that the encoded video stream is to be streamed in a burst; and sending the encoded video stream to the wireless communication unit.

Example 56 includes the subject matter of Example 55, and optionally, wherein the indication is embedded in the encoded video stream.

Example 57 includes the subject matter of Example 55 or 56, and optionally, comprising receiving the video stream and a notification that the video stream is to be streamed in a burst, and sending the encoded video stream and the indication.

Example 58 includes the subject matter of any one of Examples 55-57, and optionally, wherein the indication includes a duration of the burst, and a data size of the burst.

Example 59 includes the subject matter of any one of Examples 55-58, and optionally, comprising sending the indication a predefined time period before sending the encoded video stream to the wireless communication unit.

Example 60 includes the subject matter of any one of Examples 55-59, and optionally, comprising sending to the wireless communication unit an end indication to indicate an end of the encoded video stream.

Example 61 includes a method to be performed at a wireless communication device, the method comprising establishing a wireless communication link between the wireless communication device and a wireless display; receiving an indication that an encoded video stream is to be streamed to the wireless display in a burst; receiving the encoded video stream; and transmitting the encoded video stream to the wireless display based on the indication.

Example 62 includes the subject matter of Example 61, and optionally, comprising receiving the indication from a graphic processor via a wired link.

Example 63 includes the subject matter of Example 61, and optionally, comprising receiving the indication from an encoder.

Example 64 includes the subject matter of Example 63, and optionally, wherein the indication is embedded in the encoded video stream.

Example 65 includes the subject matter of any one of Examples 61-64, and optionally, comprising, based on the indication, switching between a first wireless communication channel to communicate with the display device, and a second wireless communication channel to communicate with one or more wireless communication devices.

Example 66 includes the subject matter of any one of Examples 61-65, and optionally, wherein the indication includes a duration of the burst, and a data size of the burst.

Example 67 includes the subject matter of any one of Examples 61-66, and optionally, comprising receiving the indication a predefined time period before reception of the encoded video stream.

Example 68 includes the subject matter of Example 67, and optionally, comprising providing a duration of the predefined time period to the encoder.

Example 69 includes the subject matter of any one of Examples 61-68, and optionally, comprising receiving an end indication to indicate an end of the video stream.

Example 70 includes a product including one or more tangible computer-readable non-transitory storage media comprising computer-executable instructions operable to, when executed by at least one computer processor, enable the at least one computer processor to implement a method at a wireless communication device, the method comprising generating a video stream to be transmitted by a wireless communication unit to a wireless display; sending to the wireless communication unit an indication that the video stream is to be streamed in a burst; and sending the video stream to the wireless communication unit.

Example 71 includes the subject matter of Example 70, and optionally, wherein the method comprises sending the indication via a wired link between the wireless communication unit and a graphic processor.

Example 72 includes the subject matter of Example 70 or 71, and optionally, wherein the method comprises encoding the video stream into an encoded video stream, and sending the encoded video stream to the wireless communication unit.

Example 73 includes the subject matter of Example 72, and optionally, wherein the method comprises sending the indication via an encoder.

Example 74 includes the subject matter of Example 72 or 73, and optionally, wherein the indication is embedded in the encoded video stream.

Example 75 includes the subject matter of any one of Examples 70-74, and optionally, wherein the indication includes a duration of the burst, and a data size of the burst.

Example 76 includes the subject matter of any one of Examples 70-75, and optionally, wherein the method comprises sending the indication a predefined time period before sending the video stream to the wireless communication unit.

Example 77 includes the subject matter of any one of Examples 70-76, and optionally, wherein the method comprises sending to the wireless communication unit an end indication to indicate an end of the video stream.

Example 78 includes a product including one or more tangible computer-readable non-transitory storage media comprising computer-executable instructions operable to, when executed by at least one computer processor, enable the at least one computer processor to implement a method at a graphic processing device, the method comprising generating a video stream to be transmitted by a wireless communication unit to a wireless display; encoding the video stream into an encoded video stream; sending to the wireless communication unit an indication that the encoded video stream is to be streamed in a burst; and sending the encoded video stream to the wireless communication unit.

Example 79 includes the subject matter of Example 78, and optionally, wherein the indication is embedded in the encoded video stream.

Example 80 includes the subject matter of Example 78 or 79, and optionally, wherein the method comprises receiving the video stream and a notification that the video stream is to be streamed in a burst, and sending the encoded video stream and the indication.

Example 81 includes the subject matter of any one of Examples 78-80, and optionally, wherein the indication includes a duration of the burst, and a data size of the burst.

Example 82 includes the subject matter of any one of Examples 78-81, and optionally, wherein the method comprises sending the indication a predefined time period before sending the encoded video stream to the wireless communication unit.

Example 83 includes the subject matter of any one of Examples 78-82, and optionally, wherein the method comprises sending to the wireless communication unit an end indication to indicate an end of the encoded video stream.

Example 84 includes a product including one or more tangible computer-readable non-transitory storage media comprising computer-executable instructions operable to, when executed by at least one computer processor, enable the at least one computer processor to implement a method at a wireless communication device, the method comprising establishing a wireless communication link between the wireless communication device and a wireless display; receiving an indication that an encoded video stream is to be streamed to the wireless display in a burst; receiving the encoded video stream; and transmitting the encoded video stream to the wireless display based on the indication.

Example 85 includes the subject matter of Example 84, and optionally, wherein the method comprises receiving the indication from a graphic processor via a wired link.

Example 86 includes the subject matter of Example 84, and optionally, wherein the method comprises receiving the indication from an encoder.

Example 87 includes the subject matter of Example 86, and optionally, wherein the indication is embedded in the encoded video stream.

Example 88 includes the subject matter of any one of Examples 84-87, and optionally, wherein the method comprises, based on the indication, switching between a first wireless communication channel to communicate with the display device, and a second wireless communication channel to communicate with one or more wireless communication devices.

Example 89 includes the subject matter of any one of Examples 84-88, and optionally, wherein the indication includes a duration of the burst, and a data size of the burst.

Example 90 includes the subject matter of any one of Examples 84-89, and optionally, wherein the method comprises receiving the indication a predefined time period before reception of the encoded video stream.

Example 91 includes the subject matter of Example 90, and optionally, wherein the method comprises providing a duration of the predefined time period to the encoder.

Example 92 includes the subject matter of any one of Examples 84-91, and optionally, wherein the method comprises receiving an end indication to indicate an end of the video stream.

Example 93 includes an apparatus comprising means for generating a video stream to be transmitted from a wireless communication device to a wireless display; means for sending to a wireless communication unit an indication that the video stream is to be streamed in a burst; and means for sending the video stream to the wireless communication unit.

Example 94 includes the subject matter of Example 93, and optionally, comprising means for sending the indication via a wired link between the wireless communication unit and a graphic processor.

Example 95 includes the subject matter of Example 93 or 94, and optionally, comprising means for encoding the video stream into an encoded video stream, and sending the encoded video stream to the wireless communication unit.

Example 96 includes the subject matter of Example 95, and optionally, comprising means for sending the indication via the encoder.

Example 97 includes the subject matter of Example 95 or 96, and optionally, wherein the indication is embedded in the encoded video stream.

Example 98 includes the subject matter of any one of Examples 93-97, and optionally, wherein the indication includes a duration of the burst, and a data size of the burst.

Example 99 includes the subject matter of any one of Examples 93-98, and optionally, comprising means for sending the indication a predefined time period before sending the video stream to the wireless communication unit.

Example 100 includes the subject matter of any one of Examples 93-99, and optionally, comprising means for sending to the wireless communication unit an end indication to indicate an end of the video stream.

Example 101 includes an apparatus comprising means for generating a video stream to be transmitted from a graphic processing device to a wireless display; means for encoding the video stream into an encoded video stream; means for sending to a wireless communication unit an indication that the encoded video stream is to be streamed in a burst; and means for sending the encoded video stream to the wireless communication unit.

Example 102 includes the subject matter of Example 101, and optionally, wherein the indication is embedded in the encoded video stream.

Example 103 includes the subject matter of Example 101 or 102, and optionally, comprising means for receiving the video stream and a notification that the video stream is to be streamed in a burst, and means for sending the encoded video stream and the indication.

Example 104 includes the subject matter of any one of Examples 101-103, and optionally, wherein the indication includes a duration of the burst, and a data size of the burst.

Example 105 includes the subject matter of any one of Examples 101-104, and optionally, comprising means for sending the indication a predefined time period before sending the encoded video stream to the wireless communication unit.

Example 106 includes the subject matter of any one of Examples 101-105, and optionally, comprising means for sending to the wireless communication unit an end indication to indicate an end of the encoded video stream.

Example 107 includes an apparatus comprising means for establishing a wireless communication link between a wireless communication device and a wireless display; means for receiving an indication that an encoded video stream is to be streamed to the wireless display in a burst; means for receiving the encoded video stream; and means for transmitting the encoded video stream to the wireless display based on the indication.

Example 108 includes the subject matter of Example 107, and optionally, comprising means for receiving the indication from a graphic processor via a wired link.

Example 109 includes the subject matter of Example 107, and optionally, comprising means for receiving the indication from an encoder.

Example 110 includes the subject matter of Example 109, and optionally, wherein the indication is embedded in the encoded video stream.

Example 111 includes the subject matter of any one of Examples 107-110, and optionally, comprising means for, based on the indication, switching between a first wireless communication channel to communicate with the display device and a second wireless communication channel to communicate with one or more wireless communication devices.

Example 112 includes the subject matter of any one of Examples 107-111, and optionally, wherein the indication includes a duration of the burst, and a data size of the burst.

Example 113 includes the subject matter of any one of Examples 107-112, and optionally, comprising means for receiving the indication a predefined time period before reception of the encoded video stream.

Example 114 includes the subject matter of Example 113, and optionally, comprising means for providing a duration of the predefined time period to the encoder.

Example 115 includes the subject matter of any one of Examples 107-114, and optionally, comprising means for receiving an end indication to indicate an end of the video stream.

Functions, operations, components and/or features described herein with reference to one or more embodiments, may be combined with, or may be utilized in combination with, one or more other functions, operations, components and/or features described herein with reference to one or more other embodiments, or vice versa.

While certain features have been illustrated and described herein, many modifications, substitutions, changes, and equivalents may occur to those skilled in the art. It is, therefore, to be understood that the appended claims are intended to cover all such modifications and changes as fall within the true spirit of the disclosure.

What is claimed is:

1. A wireless communication device comprising:
a wireless communication unit, including a transmitter and a receiver, to communicate with a wireless display; and
a graphic processor to provide a video stream to be transmitted to said wireless display, to send to said wireless communication unit an indication that said video stream is to be streamed in a burst, and to send said video stream to said wireless communication unit.

2. The wireless communication device of claim 1, wherein said graphic processor is to send said indication via a wired link between said wireless communication unit and said graphic processor.

3. The wireless communication device of claim 1 comprising an encoder to encode said video stream into an encoded video stream, and to send said encoded video stream to said wireless communication unit.

4. The wireless communication device of claim 3, wherein said graphic processor is to send said indication via said encoder.

5. The wireless communication device of claim 3, wherein said indication is embedded in said encoded video stream.

6. The wireless communication device of claim 1, wherein said indication includes a duration of said burst, and a data size of said burst.

7. The wireless communication device of claim 1, wherein said graphic processor is to send said indication a predefined time period before sending said video stream to said wireless communication unit.

8. The wireless communication device of claim 1, wherein said graphic processor is to send to said wireless communication unit an end indication to indicate an end of said video stream.

9. The wireless communication device of claim 1 comprising:
one or more antennas;
a memory; and
a processor.

10. A graphic processing device comprising:
a graphic processor to provide a video stream to be transmitted to a wireless display via a wireless communication unit; and
an encoder to encode said video stream into an encoded video stream, to send to said wireless communication unit an indication that said encoded video stream is to be streamed in a burst, and to send the encoded video stream to said wireless communication unit.

11. The graphic processing device of claim 10, wherein said indication is embedded in said encoded video stream.

12. The graphic processing device of claim 10, wherein said encoder includes a graphic driver of said graphic processor and a wireless driver of said wireless communication unit, said graphic driver to receive said video stream and a notification that said video stream is to be streamed in a burst, and said wireless driver is to send said encoded video stream and said indication.

13. The graphic processing device of claim 10, wherein said encoder is to send said indication a predefined time period before sending said encoded video stream to said wireless communication unit.

14. The graphic processing device claim 10, wherein said encoder is to send to said wireless communication unit an end indication to indicate an end of said encoded video stream.

15. A wireless communication device comprising:
an encoder to receive from a graphic processor a video stream to be transmitted to a wireless display, and to encode said video stream into an encoded video stream; and
a wireless communication unit to communicate with said wireless display, to receive an indication that said encoded video stream is to be streamed in a burst, to receive said encoded video stream from said encoder, and to transmit said encoded video stream to said wireless display based on said indication.

16. The wireless communication device of claim 15, wherein said wireless communication unit is to receive said indication from said graphic processor via a wired link between said wireless communication unit and said graphic processor.

17. The wireless communication device of claim 15, wherein said wireless communication unit is to receive said indication from said encoder.

18. The wireless communication device of claim 17, wherein said indication is embedded in said encoded video stream.

19. The wireless communication device of claim 15, wherein, based on said indication, said wireless communication unit is to switch between a first wireless communication channel to communicate with said display device, and a second wireless communication channel to communicate with one or more wireless communication devices.

20. The wireless communication device of claim 15, wherein said wireless communication unit is to receive said indication a predefined time period before reception of said encoded video stream.

21. The wireless communication device of claim 20, wherein said wireless communication unit is to provide a duration of said predefined time period to said encoder.

22. A product including one or more tangible computer-readable non-transitory storage media comprising computer-executable instructions operable to, when executed by at least one computer processor, enable the at least one computer processor to implement a method at a wireless communication device, the method comprising:
generating a video stream to be transmitted by a wireless communication unit to a wireless display;
sending to said wireless communication unit an indication that said video stream is to be streamed in a burst; and
sending said video stream to said wireless communication unit.

23. The product of claim 22, wherein said method comprises sending said indication via a wired link between said wireless communication unit and a graphic processor.

24. The product of claim 22, wherein said method comprises encoding said video stream into an encoded video stream, and sending said encoded video stream to said wireless communication unit.

25. The product of claim 24, wherein said indication is embedded in said encoded video stream.
